(19) United States
(12) Patent Application Publication
(10) Pub. No.: US 2015/0186672 A1
(43) Pub. Date: Jul. 2, 2015

(54) PHOTO PRIVACY

(71) Applicant: Yahoo! Inc., Sunnyvale, CA (US)

(72) Inventors: Benoit Schillings, Los Altos Hills, CA (US); Sophia Mah, Los Altos Hills, CA (US)

(21) Appl. No.: 14/145,669

(22) Filed: Dec. 31, 2013

(51) Int. Cl. G06F 21/62

(52) U.S. Cl. CPC G06F 21/6245

(57) ABSTRACT

In one embodiment, preferences pertaining to an entity may be obtained, where the preferences indicate whether photographing the entity is discouraged. It may be ascertained from the preferences that photographing the entity is discouraged. One or more activities may be performed according to the preferences pertaining to the entity.

### BACKGROUND

The disclosed embodiments relate generally to methods and apparatus for implementing photo privacy.

Due to their portable nature and affordability, handheld devices such as mobile phones are owned and carried by many individuals. Since handheld devices typically include a camera, individuals may be photographed at any time. These photographs may be sent to other individuals or posted online.

### SUMMARY

The disclosed embodiments enable photo privacy pertaining to an entity to be implemented. This may be accomplished based, at least in part, upon preferences indicating whether photographing the entity is discouraged.

In accordance with one embodiment, preferences pertaining to an entity may be received, where the preferences indicate whether photographing the entity is discouraged. A profile pertaining to the entity may be updated such that the profile includes the preferences pertaining to the entity. One or more activities may be performed according to the preferences pertaining to the entity.

In accordance with another embodiment, preferences pertaining to an entity may be obtained, where the preferences indicate whether photographing the entity is discouraged. It may be ascertained from the preferences pertaining to the entity that photographing the entity is discouraged. One or more activities may be performed according to the preferences pertaining to the entity.

Various embodiments may be implemented via a device comprising a processor, memory, and a display. The processor and memory are configured to perform one or more of the above described method operations. Other embodiments may be implemented via a computer readable storage medium having computer program instructions stored thereon that are arranged to perform one or more of the above described method operations.

These and other features and advantages of the disclosed embodiments will be presented in more detail in the following specification and the accompanying figures which illustrate by way of example the principles of the disclosed embodiments.

### BRIEF DESCRIPTION OF THE DRAWINGS

FIG. 1 is a diagram illustrating an example system in which various embodiments may be implemented.

FIG. 2 is a process flow diagram illustrating an example method of implementing photo privacy in accordance with various embodiments.

FIG. 3 is a process flow diagram illustrating another example method of implementing photo privacy in accordance with various embodiments.

FIG. 4 is a schematic diagram illustrating another example embodiment of a network in which various embodiments may be implemented.

FIG. 5 is a schematic diagram illustrating an example client device in which various embodiments may be implemented.

FIG. 6 is a schematic diagram illustrating an example computer system in which various embodiments may be implemented.

### DETAILED DESCRIPTION OF THE SPECIFIC EMBODIMENTS

Reference will now be made in detail to specific embodiments of the disclosure. Examples of these embodiments are illustrated in the accompanying drawings. While the disclosure will be described in conjunction with these specific embodiments, it will be understood that it is not intended to limit the disclosure to these embodiments. On the contrary, it is intended to cover alternatives, modifications, and equivalents as may be included within the spirit and scope of the disclosure as defined by the appended claims. In the following description, numerous specific details are set forth in order to provide a thorough understanding of the disclosure. The disclosed embodiments may be practiced without some or all of these specific details. In other instances, well known process operations have not been described in detail in order not to unnecessarily obscure the disclosure. The Detailed Description is not intended as an extensive or detailed discussion of known concepts, and as such, details that are known generally to those of ordinary skill in the relevant art may have been omitted or may be handled in summary fashion.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

In accordance with various embodiments, photo privacy may be implemented with respect to photographs that have been or may be taken by a camera of a mobile device, which may also be referred to as a portable device or a handheld device. Examples of a mobile device include, but are not limited to, a cellular telephone, a smart phone, a display pager, a Personal Digital Assistant (PDA), a handheld computer, a tablet computer, and a laptop computer,

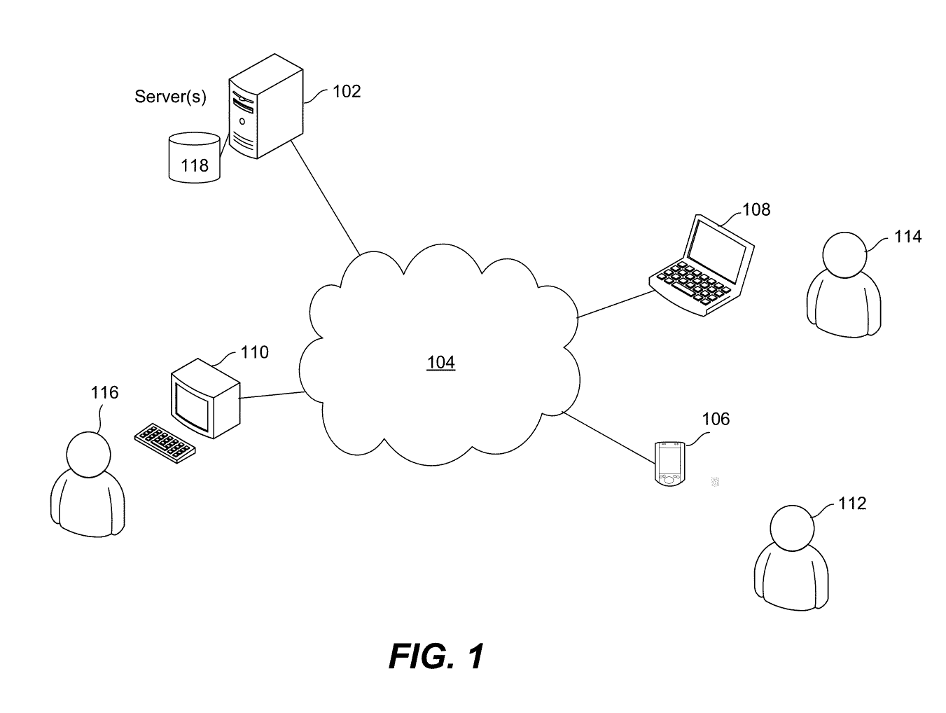

Various embodiments may be implemented, at least in part, by a mobile device and/or a remotely located server that is located in a remote location with respect to the mobile device. An example system in which various embodiments may be implemented is described in further detail below with reference to FIG. 1.

Example System

FIG. 1 is a diagram illustrating an example system in which various embodiments may be implemented. As shown in FIG. 1, the system may include one or more servers 102. In accordance with various embodiments, the servers 102 may be associated with a web site such as a social networking web site. Examples of social networking web sites include Yahoo, Facebook, Tumblr, LinkedIn, Flickr, and Meme. The server(s) 102 may enable the web site to provide a variety of services to its users. More particularly, users of the web site may perform activities such as access user accounts or public user profiles, interact with other members of the web site, transmit messages, upload files (e.g., photographs, videos), purchase goods or services, access information or content posted on the web site, etc.

In this example, the server(s) 102 may obtain or otherwise receive data (e.g., account data and/or user profile) and/or requests (e.g., requests to access the web site, search requests or account requests pertaining to a particular user account). Requests may include requests sent via the Internet 104 from one or more devices 106, 108, 110 in association with corresponding users 112, 114, 116, respectively. The server(s) 102 may personalize content to be provided to users, either automatically or in response to requests. In addition, the server(s) 102 may support photo privacy with respect to photographs that have been or may be taken by mobile device(s) such as 106 and 108, as will be described in further detail below.

The server(s) 102 may have access to one or more data stores 118 that are coupled to the server(s) 102. Each of the data stores 118 may include one or more memories. The data stores 118 may store account information (e.g., data) for a plurality of user accounts and/or profiles, content, and/or other information supporting photo privacy.

Photo privacy may be implemented with respect to mobile devices of users, who may be members or users of the web site. In the following description, examples will be described with reference to the mobile device 106 of the user 112. However, it is important to note that the disclosed embodiments may also be implemented with respect to multiple devices of a given user.

In accordance with various embodiments, the server(s) 102 and/or mobile device 106 may enable photo privacy of entities to be implemented according to corresponding photo privacy preferences. While an entity may include an individual such as a user of the web site (or mobile device), an entity need not be an individual. For example, an entity may be a landmark, building, painting, or other entity for which photo privacy is desired.

Photo Privacy Preferences

Photo privacy preferences may indicate whether photographing the entity is discouraged. For example, where the entity is an individual, the photo privacy preferences of the individual may indicate that he or she prefers not to have his or her picture taken. As another example, where an entity is a building or object, the photo privacy preferences may indicate that photographing the entity is discouraged. The photo privacy preferences may also indicate whether publicly posting photographs of the entity is discouraged.

The photo privacy preferences may further indicate or specify condition(s) that, when satisfied, trigger the sending of a notification. Notifications may be sent in the same manner regardless of the condition that is satisfied. Alternatively, a notification may be associated with a particular condition such that upon satisfaction of the particular condition, the corresponding notification is provided or initiated.

In some implementations, the photo privacy preferences may indicate whether a user wishes to receive a notification if his or her photo has been taken. The user may also indicate a manner in which the user wishes to receive a notification (e.g., pertaining to photo privacy preferences of another entity and/or a photograph that has been taken of the user). Thus, the photo privacy preferences may further include notification preferences indicating a manner in which a notification is to be transmitted. Example notification preferences include, but are not limited to, a number of notifications to be provided, a length of time that a notification is to be provided, a type of notification (e.g., audio, visual, vibration, electronic mail message, or text message), period of time or number of times the notification is to be provided, event(s) that would terminate the notification, and/or volume of the notification. For example, a user may wish for a text message to be sent to him or her if a photograph of the user has been taken.

Photo Privacy

While it will generally be difficult to prevent users from taking photographs, the server(s) 102 and/or mobile device 106 may obtain photo privacy preferences of an entity and perform one or more activities according to such preferences. More particularly, photo privacy preferences of an entity may be obtained by looking up the photo privacy preferences of the entity in a profile (e.g., at a mobile device and/or the server(s)). In addition, photo privacy preferences of an entity may be obtained by receiving a message indicating the photo privacy preferences from another device, as will be described in further detail below.

The activities that are performed according to photo privacy preferences of an entity may include providing a notification of the photo privacy preferences of the entity. The notification may be transmitted by a device to a user of the device or to another device. Such a notification may present a particular image, pattern, or other message that is recognizable by other devices or users receiving the notification. More particularly, a notification may be provided via a message such as a Radio Frequency Identifier (RFID) or infra-red signal, an audio message, a vibration, a text message, an electronic mail message, a visual signal (e.g., blinking light), forcing the user to perform additional step(s) to photograph the entity, etc.

In addition, the activities may include those that are performed with respect to a photograph that has already been taken, where the photograph includes a representation of the entity or portion thereof. For example, a notification indicating that the photograph has been taken may be transmitted to a particular individual or device. As another example, the photograph including a representation of the entity or portion thereof may be modified such that at least a portion of the photograph is blurred or removed. Once modified, the modified photograph may be stored (e.g., such that it replaces the original unmodified photograph).

Types of Notifications

As discussed above, the photo privacy system including the server(s) 102 and/or mobile device 106 may support various types of notifications. First, a notification may be provided with respect to photo privacy preferences of an entity. Second, a notification may be provided with respect to photographs taken of the entity. In some implementations, a notification pertaining to photo privacy preferences or photographs of the entity may be provided only if the photo privacy preferences of the entity indicate that photographing the entity is discouraged.

Notifications indicating photo privacy preferences of an entity may include two different types of notifications. First, a notification may be provided by a device such as a mobile device with respect to photo privacy preferences of an entity (e.g., user or owner of the mobile device) such that the notification is detectable by other mobile devices. Such a notification may include a particular image or pattern. For example, the notification may be provided via a message such as a RFID or an infra-red signal (e.g., via a particular blink pattern). The notification may be provided automatically on a periodic basis or in response to a query by another mobile device. Second, a notification may be provided via a mobile device with respect to photo privacy preferences of entities in front of or in a field of vision of a user of the mobile device such that the notification is detectable by the user. Such a notification indicating the photo privacy preferences of an entity may be provided to the user, for example, when the entity enters into or is in an estimated field of vision of the user of the mobile device or, alternatively, in response to receiving a notification indicating the photo privacy preferences of the entity from another device. For example, such a notification may include a visual signal (e.g., a particular blink pattern) or audio signal. The notification may be provided one or more times, or may be a continuous notification that is discontinued upon receiving a response from the user.

A notification indicating that a photograph including a representation of an entity or portion thereof may be provided after the photograph has been taken. The notification may be transmitted, for example, by a device via which the photograph was taken or another device (e.g., after receiving a message that includes the photograph or indicates that a photograph including a representation of the entity or portion thereof was taken). Where the entity is an individual, such a notification may be transmitted to the individual or a device of the individual. For example, the notification may be provided via a communication medium such as a text message or electronic mail message.

Notification of Photo Privacy Preferences

In accordance with various embodiments, a device used by, near, or affixed to an entity may transmit a notification indicating the photo privacy preferences of the entity. For example, the notification may include a message indicating that photographing the entity is discouraged. Such a message may include a particular pattern, image, or signal such as a RFID signal or an infra-red signal, which may be detected by another mobile device. For example, a device such as a mobile device may emit a specific infra-red blink pattern that indicates that photographing an entity in a location from which the message is received or in close proximity to the location is discouraged. In some instances, the device may include a mobile device, but need not include a mobile device.

In some instances, photo privacy preferences may be ascertained from a profile of an entity rather than signals or other messages emitted from another device. More particularly, an entity in front of the user or in the user's field of vision may first be identified. For example, a mobile device may identify an entity based upon unique signals that are emitted by a device affixed to or near the entity. As another example, a server may identify those entities in the field of vision of the user based upon tracked locations of various entities. By referencing a profile of the entity such as a user profile of an individual, it is possible for a device such as a mobile device or server to obtain the photo privacy preferences of the entity.

A server and/or a device such as a mobile device may transmit notifications indicating the photo privacy preferences of an entity to other device(s). More particularly, a device such as a mobile device may be configured to transmit a particular image, pattern, or other message. This may be accomplished, for example, by transmitting a RFID or an infra-red signal (e.g., blink pattern) indicating the photo privacy preferences of the entity. Where such a device is in front of a user or in the field of vision of the user, such a message may be detected by a mobile device of the user. In addition, a server may be configured to transmit a message indicating the photo privacy preferences of an entity in front of or in the field of vision of the user to a mobile device of the user.

In addition, user-detectable notifications of photo privacy preferences may be provided to users via their mobile devices for entities that are in front of the user. More particularly, the server(s) 102 and/or mobile device 106 may provide notifications to its users via their mobile devices for entities that are in the field of vision of the user. Notifications may not be provided for entities that are considered to be behind the user. Therefore, the notifications may be provided based, at least in part, upon a field of vision of the user.

In some embodiments, a notification may be provided to a user only if the photo privacy preferences of one of the entities in the field of vision of the user indicate that photographing the entity is discouraged. For example, a device such as a first mobile device may transmit a message (e.g., RFID or infra-red signal) indicating that photographing an entity in close proximity to the first mobile device (e.g., an owner of the mobile device) is discouraged. A second mobile device detecting such a message may provide a user-detectable notification such as an audio or visual signal, text message, or other suitable notification. In this manner, a user of the second mobile device may be notified of photo privacy preferences of entities in front of the user or within the field of vision of the user.

Notifications may be automatically provided. Alternatively, such notifications may be provided only in response to queries. For example, a first mobile device may automatically send a first message (e.g., signal) querying for photo privacy preferences, while a second device (e.g., second mobile device) receiving the first message may respond by sending a second message (e.g., signal) indicating photo privacy preferences of an entity associated with the second device. In some implementations, the second device may send the second message only if the photo privacy preferences indicate that photographing the entity is discouraged.

Field of Vision

Generally, the field of vision may refer to the area that is visible to an immobile eye at a given time. Stated another way, the field of vision may refer to the entire view encompassed by the eye trained in any particular direction. The field of vision may be the whole extent of the image falling on the retina when the eye is fixating on a given point in space. Thus, the field of vision may be the space or range within which objects are visible to immobile eyes at a given time.

While it may not be possible to precisely define an exact field of vision of the user, it is possible to estimate a field of vision of the user. In some implementations, an approximate field of vision of the user may be determined based, at least in part, upon a location of the user's mobile device and the direction in which the user of the mobile device is facing. The location of the mobile device may be ascertained via a Global Positioning System (GPS) of the mobile device. Since the mobile device may be in the user's pocket or may not currently be in use by the user, the mobile device may be in any position. As a result, it may not be possible to use the position of the mobile device to determine the direction in which the user is facing. However, when a user moves (e.g. walks or drives), it may be assumed that the user is facing in the direction in which the user is moving. As a result, the direction in which the user of the mobile device is facing may be assumed based upon the dominant direction in which the user is moving or has most recently moved. More particularly, the dominant forward direction of motion of the mobile device may be ascertained based, at least in part, upon an accelerometer and/or GPS. Therefore, the dominant current or recent direction of motion of the mobile device may indicate the direction that the user is likely facing. Accordingly, the field of vision of the user of the mobile device may be determined based, at least in part, on the location of the mobile device and the dominant direction of motion (e.g., current or most recent) of the mobile device.

In some implementations, a transformation may be applied to ascertain an orientation of the mobile device (e.g., in a pocket of the user) with respect to the direction that the user is facing. The orientation of the mobile device may further assist in approximating the field of vision of the user.

The field of vision may be an estimated area, which may be defined by a region that may be located on a map. For example, it may be assumed that the user can view objects within a distance of one mile away. The distance may extend in front of the user, as well as to the sides of the user. Thus, the field of vision may be an area in the shape of a semi-circle. The semi-circle may be defined, for example, by a particular radius and range of angles with respect to the location of the mobile device of the user. As another example, the field of vision may be a triangular area that extends outward from the user. In this manner, a region defining the user's likely field of vision may be estimated.

Photo Privacy System

In accordance with various embodiments, the server(s) 102 and/or mobile device 106 may implement photo privacy policies according to photo privacy preferences. As described herein, the server(s) 102 and/or mobile device 106 may send notifications and/or modify photographs according to the pertinent photo privacy preferences. More particularly, the server(s) and/or mobile device 106 may send notifications of photo privacy preferences. In addition, the server(s) 102 and/or mobile device 106 may ascertain when a photograph including a representation of an entity or portion thereof has been taken, and send notification(s) and/or modify the photograph according to the pertinent photo privacy preferences.

Photo privacy preferences for an entity may be established via the server(s) 102 and/or the mobile device 106. Such photo privacy preferences may be statically or dynamically configured. Dynamic configuration may be achieved in response to receiving photo privacy preferences from a user. Similarly, previously configured photo privacy preferences may be modified. Configuration or modification of photo privacy preferences may be performed via a graphical user interface such as a menu that is rendered via the server(s) 102 and/or the mobile device 106.

Photo privacy preferences for an entity may be maintained in a corresponding profile. The server(s) 102 may maintain profiles for a plurality of entities. Similarly, a mobile device 106 may maintain a profile for each of one or more entities. The mobile device 106 may transmit profile(s) and/or updates to profile(s) to the server(s) and vice versa. Where photo privacy preferences are configured in a profile at a mobile device, the mobile device may transmit messages (e.g., indicating photo privacy preferences) according to the photo privacy preferences, as described herein. A profile may be associated with particular entities, which may include individuals, mobile devices, buildings, objects, etc.

While a set of photo privacy preferences may be applied to all users of a mobile device, it is also possible to apply different photo privacy preferences to different users of a mobile device. More particularly, a photo privacy preference may be associated with a particular user and/or mobile device(s). A user may be identified by an identifier such as a username, an email address, deoxyribonucleic acid (DNA), retina scan, fingerprint, and/or other identifying information. A mobile device may be identified by an identifier such as an Internet Protocol (IP) address.

Photo privacy preferences may be established as a set of default notification preferences. Moreover, users may establish photo privacy preferences or modify existing photo privacy preferences. Photo privacy preferences may be established via the web site and/or may be generated locally at the mobile device 106. Profiles such as user profile(s) including photo privacy preferences may be stored remotely by the server(s) 102 (e.g., at the data store(s) 118) and/or locally at the corresponding mobile devices 106, 108, 110.

In accordance with various embodiments, photo privacy may be personalized for an individual based, at least in part, upon a user profile of the individual. Examples of information that may be maintained in a user profile will be described in further detail below.

A profile such as a user profile may be updated under various circumstances. As will be described in further detail below, an enormous amount of information may be collected via web sites based upon various interactions (or lack thereof) of individuals with the content provided via the web sites. For example, the web sites may ascertain whether the individuals access specific content, which may or may not have been recommended by the web sites. As another example, the web sites may record a number of clicks by individuals to various content items. In addition, the user profile may be updated based upon content or applications accessed via a mobile device (e.g., in response to messages or requests transmitted by the mobile device to the server(s)) 102, as well as photo privacy preferences that have been obtained.

The information that is obtained by the server(s) 102 may be stored to the data stores 118. More particularly, the information may be stored, maintained, and/or updated in the data stores 118 such that the information is associated with the corresponding user. The information may include that gathered or obtained by the server(s) 102 as well as that received from other device(s), which may include a mobile device. A description of the information that may be stored, maintained, and updated in the data stores 118 will be described in further detail below.

Data Stores and User Profiles

The data stores 118 may store content or references to content, which may include content items, hypertext links via which content items may be accessed, and/or URLs via which content items may be accessed. The content may be indexed for efficient retrieval.

Content may include digital media items, which may include text, audio, video, photographs, and/or other images. For example, digital media items may be accessed via a corresponding Uniform Resource Locator (URL). The term content as used herein may refer to a collection of content or a specific content item, which may be one of a plurality of content items within a collection of content.

Content accessible via the Internet may be contained within an object, such as a Web object, web page, web site, electronic document, or the like. An item in a collection of content may be referred to as an “item of content” or a “content item,” and may be retrieved from a “Web of Objects” comprising objects made up of a variety of types of content. For example, a newspaper available via a particular web site may serve as a collection of content that includes a plurality of content items.

In addition, the data stores 118 may store information such as the characteristics of the content, which may be stored in association with the content. More particularly, the content may be a collection of content or a specific content item, which may be one of a plurality of content items within a collection of content. For example, the characteristics of the content may indicate information such as an identifier of a content item (e.g., a pointer to a digital version of a content item or title of the content item), a primary subject or topic of the content item, one or more key words, results of analysis of the content item, one or more content categories indicating subject matter to which the content item relates, and/or an author or source of the content item.

Content and/or characteristics of content within a repository of media or multimedia within the data stores 118 may be annotated. Examples of content may include text, images, audio, video, or the like, which may be processed or stored in memory. The term “annotation,” as used herein, refers to descriptive or contextual content related to a content item, for example, collected from (or transmitted to) an individual, such as a user, and stored in association with the individual or the content item. Annotations may include various fields of descriptive content, such as a rating of a document, circumstances or context pertaining to the receipt of a document, a list of keywords identifying topics of a document, etc.

In some embodiments, as an individual interacts with a software application or a device such as a mobile device, descriptive content such as, for example, a date and/or time, may be identified and stored in the data stores 118 such that the descriptive content is stored in association with content. Descriptive content may also be stored along with contextual content. For example, how content such as a content item came to be identified (e.g., it was contained in a particular web page) may be stored in the data stores 118 as contextual content associated with the content. Contextual content, therefore, may identify circumstances surrounding receipt of content (e.g., date or time a content item was received or consumed and/or a source of the content item) and may be associated with descriptive content in the data stores 118. Contextual content, may, for example, be used to subsequently search for associated descriptive content. Accordingly, this additional contextual content and/or descriptive content may enable personalization to be performed based upon the information that is most likely to be relevant.

In addition, the data stores 118 may include account information (e.g., data) for a plurality of user accounts. Therefore, account information pertaining to user accounts may be retained in one or more memories that are coupled to the server 102.

The account information retained in the data stores 118 may include financial information such as credit card information, enabling goods or services provided in association with the account to be purchased. In addition, the account information may include information pertaining to goods or services available to the user via the user account or used by the user. More particularly, the account information may indicate an amount and/or quality of the goods or services available to the user or used by the user. In addition, the account information may indicate a cost associated with the amount and/or quality of goods or services available to the user or used by the user.

The account information may also include or be linked to additional information pertaining to the user. For example, the server(s) 102 may have access to additional user information, which may be retained in one or more user logs stored in the data stores 118. This user information or a portion thereof may be referred to as a user profile. More particularly, the user profile may include public information that is available in a public profile and/or private information. Furthermore, the user profile may include information that has been submitted by the user and/or information that has been deduced or automatically collected by the system (e.g., based upon user action(s)). In accordance with various embodiments, as an individual consumes content provided via a web site or via a device such as a mobile device, the user profile may be updated.

A profile builder may initiate generation of a profile, such as for users of an application, including a search engine or messaging application, for example. A profile builder may initiate generation of a user profile for use, for example, by a user, as well as by an entity that may have provided the application. For example, a profile builder may enhance relevance determinations and thereby assist in indexing, searching or ranking search results, as well as assist in the identification of further content to be provided via various media. Therefore, a provider such as a search engine provider may employ a profile builder.

A variety of mechanisms may be implemented to generate and/or update a profile including, but not limited to, collecting or mining navigation history, stored documents, tags, or annotations, to provide a few examples. In addition, the profile may be updated with information gathered as a result of the use of a device such as a mobile device. A profile builder may store a generated or updated profile.

The user information retained in the user logs 118 may include personal information such as demographic information and/or geographic information. Examples of demographic information include age and gender. Examples of geographic information include residence address, work address, and/or zip code.

Each time an individual performs online activities such as clicking on a content item (e.g., an advertisement or media item), purchasing goods or services, sending messages, retrieving messages, accessing a media item, posting information or content, or annotating content, information regarding such activity or activities may be retained as user data in the user logs 118. For instance, the user data that is retained in the user logs 118 may indicate the identity of web sites visited, identity of ads or content items that have been selected (e.g., clicked on) via the web site, and/or a timestamp indicating a date and/or time that the individual viewed or accessed the content item. Moreover, where the online publisher supports a search engine (e.g., via the server 102 or a separate search server), information associated with a search query, such as search term(s) of the search query, information indicating characteristics of search results that have been selected (e.g., clicked on) by the individual, and/or associated timestamp may also be retained in the user logs 118. Thus, the information may indicate whether the individual clicked on or viewed a content item and, if so, the number of clicks or views within a particular time period. An individual may be identified in the user logs 118 by a user ID (e.g., user account ID), email address, DNA, fingerprint, information in a user cookie, etc.

Each user profile may be associated with an individual and/or device, which may be identified by a device identifier such as an Internet Protocol (IP) address. Although user profiles are described with reference to data store(s) 118 coupled to the server(s) 102, such a user profile may also be stored, maintained, and/or updated locally at the mobile device 106.

A user profile may include a set of user preferences. In some embodiments, the set of user preferences includes a set of photo privacy preferences. The set of photo privacy preferences may be a default configuration or may be established by a user, enabling photo privacy to be implemented in accordance with the set of photo privacy preferences. A set of photo privacy preferences may be associated with an entity such as a user and/or device. The set of photo privacy preferences may indicate whether photographing the entity is discouraged. In addition, the set of photo privacy preferences may indicate that the user wishes to be notified upon satisfaction of a particular condition. For example, the user may wish to be notified when a photograph of the user has been taken. The set of photo privacy preferences may further indicate a manner in which the user wishes to be notified. For example, the user may specify that they wish to be notified via electronic mail or text message if a photograph of the user has been taken.

Each mobile device 106 may also store one or more user profiles including one or more sets of photo privacy preferences, which may be associated with one or more users. Information stored in a user profile at the mobile device 106 may be shared with (e.g., transmitted to) the server(s). Similarly, information stored in a user profile at the server(s) 102 may be shared with (e.g., transmitted to) the mobile device(s) 106.

Where a user profile is stored at the mobile device, the locally stored user profile may include less information than a user profile that is stored remotely. For example, the locally stored user profile may include a set of photo privacy preferences, but may not include information pertaining to the user's browsing activity. Therefore, a user profile stored at the mobile device need not be identical to a remotely stored user profile.

Based upon the information recorded in user profiles, it is possible to identify characteristics of items (e.g., content) that may be of interest to individuals (or a similarly situated group of individuals). For example, through the use of user profiles, a web site such as a search engine provider may retrieve annotations, tags, stored pages, navigation history, or the like, which may be useful for making relevance determinations of search results or content.

In addition, photo privacy may be achieved based, at least in part, upon photo privacy preferences in user profiles. This may be accomplished via notifications and/or photo modification, as described herein.

### EXAMPLE EMBODIMENTS

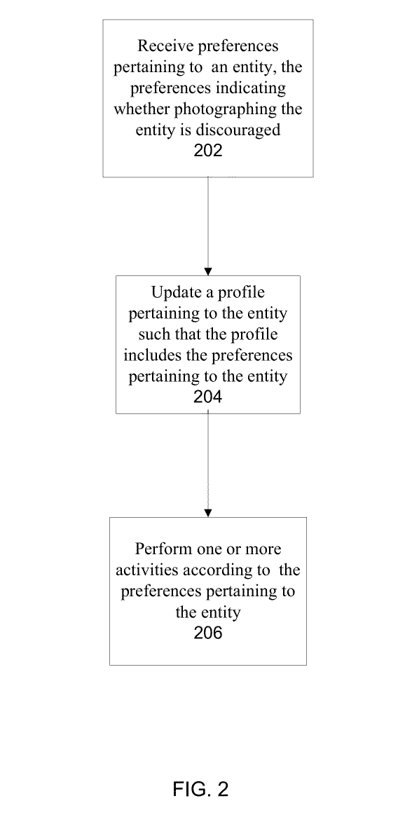

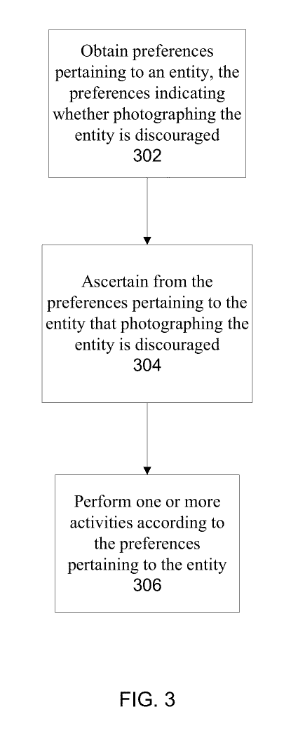

The disclosed embodiments may be implemented at the server(s) and/or the mobile device. Various example methods of implementing photo privacy will be described in further detail below with reference to FIG. 2 and FIG. 3.

Photo Privacy Process

When a user turns on or otherwise accesses a mobile device, an identity of the user of the mobile device may be ascertained via a variety of mechanisms. In some embodiments, an identity of the user (e.g., owner) of the device may be statically configured. Thus, the device may be keyed to an owner or multiple owners. In other embodiments, the device may automatically determine the identity of the user of the device. For instance, a user of the device may be identified by DNA, a retina scan, and/or finger print. In yet other embodiments, the user may submit an identifier (e.g., username or email address) and/or information for authenticating the user (e.g., password).

In addition, an identifier associated with the mobile device may be obtained. For example, the identifier associated with the mobile device may include an IP address. The identifier may be statically or dynamically configured at the mobile device.

The identity of the user of the mobile device and/or the identity of the mobile device may be used to identify a corresponding profile. Photo privacy may then be implemented according to the photo privacy preferences in the profile.

Where a profile is not stored locally at the mobile device, information including the identity of the user and/or an identity of the mobile device may be transmitted by the mobile device to the server(s). The server(s) may identify a profile corresponding to the identity of the user of the mobile device and/or the identity of the mobile device. The server(s) may then transmit the user profile or photo privacy preferences to the mobile device for use in implementing photo privacy. In addition, the server(s) may implement photo privacy based, at least in part, upon the photo privacy preferences in the user profile.

Similarly, where a user profile is generated and/or stored locally, the mobile device may identify a profile such as a user profile (e.g., corresponding to the identity of the user). The mobile device may transmit the user profile or set of photo privacy preferences therein to the remotely located server(s) for storage at the remotely located data store(s). Therefore, photo privacy may be implemented by the mobile device and/or the server(s) based, at least in part, upon the photo privacy preferences in the user profile.

Photo privacy may be implemented according to photo privacy preferences of a profile such as a user profile. Example methods of implementing photo privacy will be described below with reference to FIG. 2 and FIG. 3.

FIG. 2 is a process flow diagram illustrating an example method of implementing photo privacy in accordance with various embodiments. The server(s) and/or mobile device may receive preferences pertaining to an entity at 202, where the preferences indicate whether photographing the entity is discouraged. For example, the mobile device may receive the preferences from a user or another device, which may be the server or another mobile device. As another example, the server(s) may receive the preferences from a user or a device, which may be a mobile device. The preferences may be received from a device via a message, which may include an image or pattern such as that transmitted via a RFID or an infra-red signal. In some instances, the preferences may indicate that photographing the entity is discouraged.

In some instances, preferences may be received from another device in response to a query. More particularly, the mobile device may transmit a query for photo privacy preferences of other device(s) that could be in front of or in a field of vision of a user of the mobile device. For example, this may be accomplished by querying all devices within a particular radius of the mobile device and within a particular range of angles with respect to the mobile device. In this manner, it is possible to identify those entities within the field of vision of the user that have a “no picture” policy.

Where preferences are transmitted by another device, the mobile device may detect the preferences via a number of mechanisms. More particularly, the mobile device may detect a message, which may include a particular image, pattern, or signal indicating the preferences of an entity associated with the device. For example, the mobile device may detect a specific infra-red blink pattern emitted from the device.

The server(s) and/or mobile device may update a profile pertaining to the entity at 204 such that the profile includes the preferences pertaining to the entity. For example, where the entity is an individual, the profile may include a user profile.

The server(s) and/or mobile device may perform one or more activities according to the preferences pertaining to the entity at 206. In some embodiments, these activities may be performed only if the preferences indicate that photographing the entity is discouraged.

As described above, these activities may include providing a notification indicating the preferences of the entity. More particularly, a notification indicating the preferences pertaining to the entity may be transmitted to one or more devices. Thus, the notification may be provided such that it is detectable by another device. More particularly, the notification may include an image, pattern, or other message. For example, the notification may be transmitted via a particular RFID or infra-red signal pattern. In some implementations, the notification may further indicate a geographic location of the entity or a geographic region including the entity. In addition, the notification may be provided such that it is detectable by a user. For example, the notification may be provided via a vibration, audio notification, visual notification (e.g., blinking light), electronic mail, or text message.

Where a photograph including a representation of the entity or portion thereof has been taken, the activities may further include modifying the photograph and/or sending a notification pertaining to the photograph. More particularly, once a photograph including a representation of the entity or portion thereof has been identified or received, the photograph including the representation of the entity or portion thereof may be modified such that at least a portion of the photograph including the representation of the entity or portion thereof is blurred or removed. The modified photograph may then be stored. In addition, a notification indicating that a photograph including a representation of the entity or portion thereof has been taken may be transmitted. For example, where the photograph is of a particular individual, the notification may be transmitted to the individual via electronic mail or text message.

In some implementations, the activities performed by the server(s) and/or the mobile device are initiated in response to a message that is received from a device. More particularly, the message may pertain to photographing the entity. For example, such a message may include: 1) an identifier of the entity, a geographic location of the entity, or a geographic region including the entity, 2) a query for photo privacy preferences, 3) a photograph including a representation of the entity or portion thereof, and/or 4) a notification that a photograph including a representation of the entity or portion thereof has been taken. The information may be obtained from the message and stored in association with the entity.

FIG. 3 is a process flow diagram illustrating another example method of implementing photo privacy in accordance with various embodiments. The server(s) and/or mobile device may obtain preferences pertaining to an entity at 302, where the preferences indicate whether photographing the entity is discouraged. For example, the mobile device may obtain preferences that are locally stored, receive preferences from the server, or receive (e.g., detect) preferences that are transmitted by another device, which may be a mobile device. As another example, the server(s) may obtain preferences that are stored at the server(s) or receive preferences from another device, which may be a mobile device. The preferences received from a device may include an image, pattern, or other message, which may include a RFID or infra-red signal.

In some instances, preferences may be received from another device in response to a query. More particularly, the mobile device may transmit a query for photo privacy preferences of other device(s) that could be in front of or in a field of vision of a user of the mobile device. For example, this may be accomplished by querying all devices within a particular radius of the mobile device and within a particular range of angles with respect to the mobile device. In this manner, it is possible to identify those entities within the field of vision of the user that have a “no picture” policy.

Where preferences are transmitted by another device, the mobile device may detect the preferences via a number of mechanisms. More particularly, the mobile device may detect a particular image, pattern, or signal indicating the preferences of an entity associated with the device. For example, the mobile device may detect a specific infra-red blink pattern emitted from the device.

The server(s) and/or mobile device may ascertain from the preferences pertaining to the entity at 304 that photographing the entity is discouraged. This may be accomplished, for example, by performing pattern or image recognition to accurately interpret preferences transmitted by another device. For example, wherein the entity is an individual, the preferences may indicate that the individual does not wish to have their photograph taken.

The server(s) and/or mobile device may perform one or more activities according to the preferences pertaining to the entity at 306. In some embodiments, these activities may be performed only if the preferences indicate that photographing the entity is discouraged. As described above, these activities may include providing a notification indicating the preferences of the entity. More particularly, a notification indicating the preferences pertaining to the entity may be transmitted to one or more devices. In some implementations, the notification may further indicate a geographic location of the entity or a geographic region including the entity. The notification may include a pattern, image, or other message that is provided such that it is detectable by another device. For example, the notification may include a RFID or infra-red signal. In addition, the notification may be provided such that it is detectable by a user. For example, the notification may be provided via a vibration, an audio notification, a visual notification (e.g., blinking light), an electronic mail message, or a text message.

Where a photograph including a representation of the entity or portion thereof has been taken, the activities may further include modifying the photograph and/or sending a notification pertaining to the photograph. More particularly, once a photograph including a representation of the entity or portion thereof has been identified or received, the photograph including the representation of the entity or portion thereof may be modified such that at least a portion of the photograph including the representation of the entity or portion thereof is blurred or removed. The modified photograph may then be stored. In addition, a notification indicating that a photograph including a representation of the entity or portion thereof has been taken may be transmitted. For example, where the photograph is of a particular individual, the notification may be transmitted to the individual via electronic mail or text message.

In some implementations, the activities performed by the server(s) and/or the mobile device are initiated in response to a message that is received from a device. More particularly, the message may pertain to photographing the entity. For example, such a message may include: 1) an identifier of the entity, a geographic location of the entity, or a geographic region including the entity, 2) a query for photo privacy preferences, 3) a photograph including a representation of the entity or portion thereof, and/or 4) a notification that a photograph including a representation of the entity or portion thereof has been taken. Information or files may be obtained from the message and stored in association with the entity.

Network

A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

Content Distribution Network

A distributed system may include a content distribution network. A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

Peer-to-Peer Network

A peer-to-peer (or P2P) network may employ computing power or bandwidth of network participants in contrast with a network that may employ dedicated devices, such as dedicated servers, for example; however, some networks may employ both as well as other approaches. A P2P network may typically be used for coupling nodes via an ad hoc arrangement or configuration. A peer-to-peer network may employ some nodes capable of operating as both a “client” and a “server.”

Wireless Network

A wireless network may couple client devices with a network. A wireless network may employ stand-alone ad-hoc networks, mesh networks, Wireless LAN (WLAN) networks, cellular networks, or the like.

A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Internet Protocol

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6.

The Internet refers to a decentralized global network of networks. The Internet includes LANs, WANs, wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

Social Network

The term “social network” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like.

A social network may include individuals with similar experiences, opinions, education levels or backgrounds. Subgroups may exist or be created according to user profiles of individuals, for example, in which a subgroup member may belong to multiple subgroups. An individual may also have multiple “1:few” associations within a social network, such as for family, college classmates, or co-workers.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so called ‘virtual persons.’ An individual's social network may be represented in a variety of forms, such as visually, electronically or functionally. For example, a “social graph” or “socio-gram” may represent an entity in a social network as a node and a relationship as an edge or a link.

Multi-Modal Communication (MMC)

Individuals within one or more social networks may interact or communicate with other members of a social network via a variety of devices. Multi-modal communication technologies refers to a set of technologies that permit interoperable communication across multiple devices or platforms, such as cellphones, smart phones, tablet computing devices, personal computers, televisions, SMS/MMS, email, instant messenger clients, forums, social networking sites (such as Facebook, Twitter, or Google), or the like.

Network Architecture

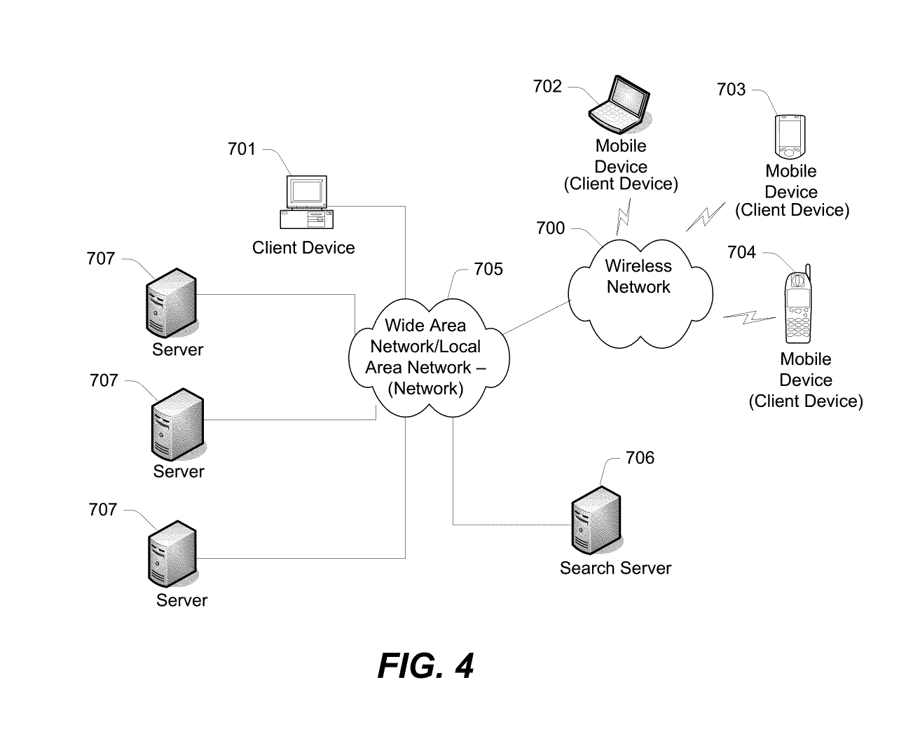

The disclosed embodiments may be implemented in any of a wide variety of computing contexts. FIG. 4 is a schematic diagram illustrating an example embodiment of a network. Other embodiments that may vary, for example, in terms of arrangement or in terms of type of components, are also intended to be included within claimed subject matter. Implementations are contemplated in which users interact with a diverse network environment. As shown, FIG. 4, for example, includes a variety of networks, such as a LAN/WAN 705 and wireless network 700, a variety of devices, such as client devices 701-704, and a variety of servers such as content server(s) 707 and search server 706. The servers may also include an ad server (not shown). As shown in this example, the client devices 701-704 may include one or more mobile devices 702, 703, 704. Client device(s) 701-704 may be implemented, for example, via any type of computer (e.g., desktop, laptop, tablet, etc.), media computing platforms (e.g., cable and satellite set top boxes), handheld computing devices (e.g., PDAs), cell phones, or any other type of computing or communication platform.

The disclosed embodiments may be implemented in some centralized manner. This is represented in FIG. 4 by server(s) 707, which may correspond to multiple distributed devices and data store(s). The server(s) 707 and/or corresponding data store(s) may store user account data, user information, and/or content.

Server

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Content Server

A content server may comprise a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor-type or programmable consumer electronics, etc.

Crawler

A crawler may be operable to communicate with a variety of content servers, typically via a network. In some embodiments, a crawler starts with a list of URLs to visit. The list may be called a seed list. As the crawler visits the URLs in the seed list, it identifies all the hyperlinks in the page and adds them to a list of URLs to visit, called the crawl frontier. URLs from the crawler frontier are recursively visited according to a set of policies. A crawler typically retrieves files by generating a copy for storage, such as local cache storage. A cache refers to a persistent storage device. A crawler may likewise follow links, such as HTTP hyperlinks, in the retrieved file to additional files and may retrieve those files by generating copy for storage, and so forth. A crawler may therefore retrieve files from a plurality of content servers as it “crawls” across a network.

Indexing

An indexer may be operable to generate an index of content, including associated contextual content, such as for one or more databases, which may be searched to locate content, including contextual content. An index may include index entries, wherein an index entry may be assigned a value referred to as a weight. An index entry may include a portion of the database. In some embodiments, an indexer may use an inverted index that stores a mapping from content to its locations in a database file, or in a document or a set of documents. A record level inverted index contains a list of references to documents for each word. A word level inverted index additionally contains the positions of each word within a document. A weight for an index entry may be assigned. For example, a weight, in one example embodiment may be assigned substantially in accordance with a difference between the number of records indexed without the index entry and the number of records indexed with the index entry.

Client Device

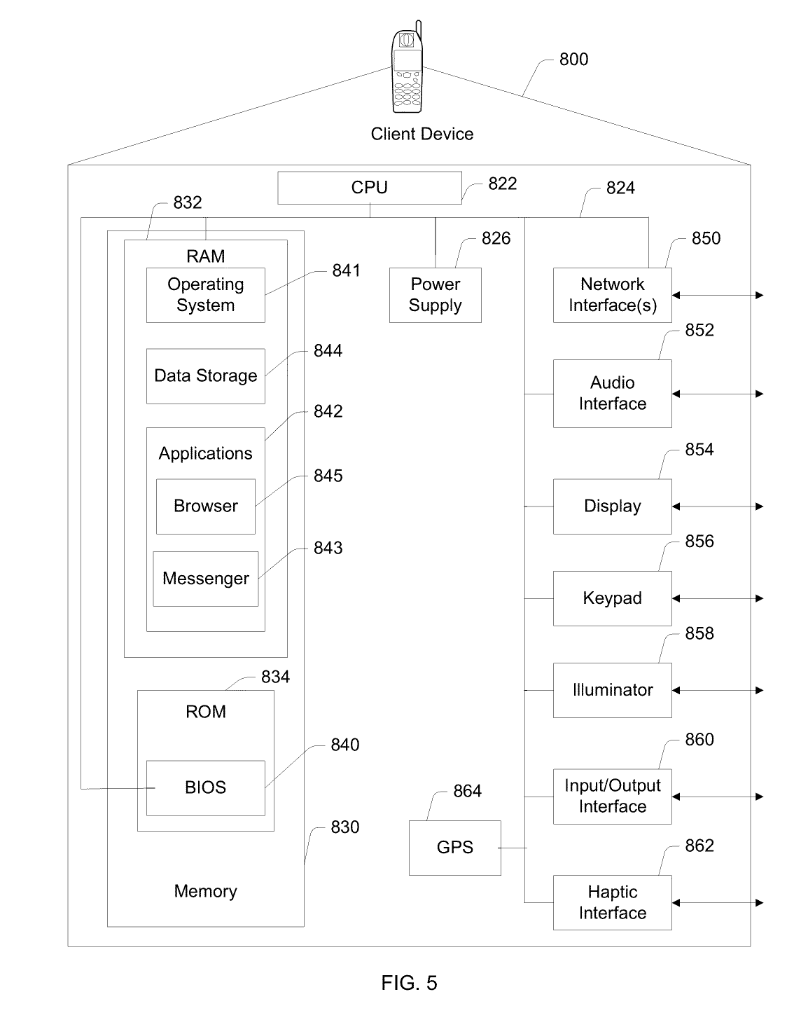

FIG. 5 is a schematic diagram illustrating an example embodiment of a client device in which various embodiments may be implemented. A client device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like. A portable device may also be referred to as a mobile device or handheld device.

As shown in this example, a client device 800 may include one or more central processing units (CPUs) 822, which may be coupled via connection 824 to a power supply 826 and a memory 830. The memory 830 may include random access memory (RAM) 832 and read only memory (ROM) 834. The ROM 834 may include a basic input/output system (BIOS) 840.

The RAM 832 may include an operating system 841. More particularly, a client device may include or may execute a variety of operating systems, including a personal computer operating system, such as a Windows, iOS or Linux, or a mobile operating system, such as iOS, Android, or Windows Mobile, or the like. The client device 800 may also include or may execute a variety of possible applications 842 (shown in RAM 832), such as a client software application such as messenger 843, enabling communication with other devices, such as communicating one or more messages, such as via email, short message service (SMS), or multimedia message service (MMS), including via a network, such as a social network, including, for example, Facebook, LinkedIn, Twitter, Flickr, or Google, to provide only a few possible examples. The client device 800 may also include or execute an application to communicate content, such as, for example, textual content, multimedia content, or the like, which may be stored in data storage 844. A client device may also include or execute an application such as a browser 845 to perform a variety of possible tasks, such as browsing, searching, playing various forms of content, including locally stored or streamed video, or games (such as fantasy sports leagues).

The client device 800 may send or receive signals via one or more interface(s). As shown in this example, the client device 800 may include one or more network interfaces 850. The client device 800 may include an audio interface 852. In addition, the client device 800 may include a display 854 and an illuminator 858. The client device 800 may further include an Input/Output interface 860, as well as a Haptic Interface 862 supporting tactile feedback technology.

The client device 800 may transmit and detect patterns, images, or signals such as infra-red signals via the interface(s). For example, the client device 800 may transmit an infra-red blink pattern, as well as detect an infra-red blink pattern, as described herein.

The client device 800 may vary in terms of capabilities or features. Claimed subject matter is intended to cover a wide range of potential variations. For example, a cell phone may include a keypad such 856 such as a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) 864 or other location identifying type capability, or a display with a high degree of functionality, such as a touch-sensitive color 2D or 3D display, for example. The foregoing is provided to illustrate that claimed subject matter is intended to include a wide range of possible features or capabilities.

According to various embodiments, input may be obtained using a wide variety of techniques. For example, input for downloading or launching an application may be obtained via a graphical user interface from a user's interaction with a local application such as a mobile application on a mobile device, web site or web-based application or service and may be accomplished using any of a variety of well-known mechanisms for obtaining information from a user. However, it should be understood that such methods of obtaining input from a user are merely examples and that input may be obtained in many other ways.

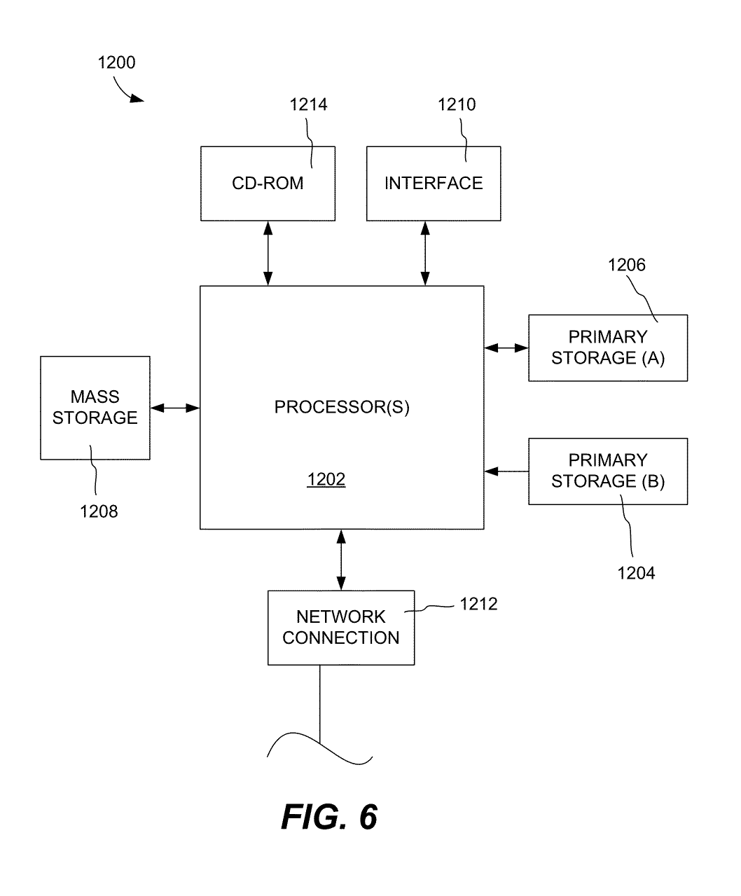

FIG. 6 illustrates a typical computer system that, when appropriately configured or designed, can serve as a system via which various embodiments may be implemented. The computer system 1200 includes any number of CPUs 1202 that are coupled to storage devices including primary storage 1206 (typically a RAM), primary storage 1204 (typically a ROM). CPU 1202 may be of various types including microcontrollers and microprocessors such as programmable devices (e.g., CPLDs and FPGAs) and unprogrammable devices such as gate array ASICs or general purpose microprocessors. As is well known in the art, primary storage 1204 acts to transfer data and instructions uni-directionally to the CPU and primary storage 1206 is used typically to transfer data and instructions in a bi-directional manner. Both of these primary storage devices may include any suitable computer-readable media such as those described above. A mass storage device 1208 is also coupled bi-directionally to CPU 1202 and provides additional data storage capacity and may include any of the computer-readable media described above. Mass storage device 1208 may be used to store programs, data and the like and is typically a secondary storage medium such as a hard disk. It will be appreciated that the information retained within the mass storage device 1208, may, in appropriate cases, be incorporated in standard fashion as part of primary storage 1206 as virtual memory. A specific mass storage device such as a CD-ROM 1214 may also pass data uni-directionally to the CPU.

CPU 1202 may also be coupled to an interface 1210 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1202 optionally may be coupled to an external device such as a database or a computer or telecommunications network using an external connection as shown generally at 1212. With such a connection, it is contemplated that the CPU might receive information from the network, or might output information to the network in the course of performing the method steps described herein.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store instructions for performing the disclosed methods, graphical user interfaces to be displayed in association with the disclosed methods, etc.

Because such information and program instructions may be employed to implement the systems/methods described herein, the disclosed embodiments relate to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as optical disks; and hardware devices that are specially configured to store and perform program instructions, such as ROM and RAM. Examples of program instructions include both machine code, such as produced by a compiler, and files containing higher level code that may be executed by the computer using an interpreter.

Computer program instructions with which various embodiments are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The disclosed techniques may be implemented in any suitable combination of software and/or hardware system, such as a web-based server or desktop computer system. Moreover, a system implementing various embodiments may be a portable device, such as a laptop or cell phone. An apparatus and/or web browser may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the disclosed method steps.

Although the foregoing embodiments have been described in some detail for purposes of clarity of understanding, it will be apparent that certain changes and modifications may be practiced within the scope of the appended claims. Therefore, the present embodiments are to be considered as illustrative and not restrictive, and are not to be limited to the details given herein, but may be modified within the scope and equivalents of the appended claims.

What is claimed is:

1. A method, comprising:
receiving preferences pertaining to an entity, the preferences indicating whether photographing the entity is discouraged;
updating a profile pertaining to the entity such that the profile includes the preferences pertaining to the entity; and
performing one or more activities according to the preferences pertaining to the entity.

2. The method as recited in claim 1, wherein performing one or more activities comprises:
transmitting a notification indicating the preferences pertaining to the entity.

3. The method as recited in claim 1, wherein performing one or more activities comprises:
identifying or receiving a photograph including a representation of the entity or portion thereof;
modifying the photograph including the representation of the entity or portion thereof such that at least a portion of the photograph including the representation of the entity or portion thereof is blurred or removed; and
storing the modified photograph.

4. The method as recited in claim 1, wherein performing one or more activities comprises:
transmitting a notification that a photograph including a representation of the entity or portion thereof has been taken.

5. The method as recited in claim 1, further comprising:
receiving a message from a device, the message pertaining to photographing the entity;
wherein performing at least one of the activities is initiated in response to the message.

6. The method as recited in claim 5, wherein the message comprises 1) an identifier of the entity, a geographic location of the entity, or a geographic region including the entity, 2) a query, 3) a photograph including a representation of the entity or portion thereof, and/or 4) a notification that a photograph including a representation of the entity or portion thereof has been taken.

7. An apparatus, comprising:
a processor; and
a memory, at least one of the processor or the memory being adapted for:
obtaining preferences pertaining to an entity, the preferences indicating whether photographing the entity is discouraged;
ascertaining from the preferences pertaining to the entity that photographing the entity is discouraged; and
performing one or more activities according to the preferences pertaining to the entity.

8. The apparatus as recited in claim 7, wherein performing one or more activities comprises:
providing a notification indicating the preferences pertaining to the entity.

9. The method as recited in claim 8, wherein the notification is transmitted when the entity enters into or is in an estimated field of vision of a user of the apparatus.

10. The apparatus as recited in claim 7, wherein performing one or more activities comprises:
identifying or receiving a photograph including a representation of the entity or portion thereof;
modifying the photograph including the representation of the entity or portion thereof such that at least a portion of the photograph including the representation of the entity or portion thereof is blurred or removed; and
storing the modified photograph.

11. The apparatus as recited in claim 7, wherein performing one or more activities comprises:
providing a notification that a photograph including a representation of the entity or portion thereof has been taken.

12. The apparatus as recited in claim 7, at least one of the processor or the memory being further adapted for performing operations, comprising:
receiving a message from a device, the message pertaining to photographing the entity;
wherein performing at least one of the activities is initiated in response to the message.

13. The apparatus as recited in claim 12, wherein the message comprises 1) an identifier of the entity, a geographic location of the entity, or a geographic region including the entity, 2) a query, 3) a photograph including a representation of the entity or portion thereof, and/or 4) a notification that a photograph including a representation of the entity or portion thereof has been taken.

14. The apparatus as recited in claim 7, wherein the apparatus comprises a mobile device.

15. A method, comprising:
obtaining preferences pertaining to an entity, the preferences indicating whether photographing the entity is discouraged;
ascertaining from the preferences pertaining to the entity that photographing the entity is discouraged; and
performing one or more activities according to the preferences pertaining to the entity.

16. The method as recited in claim 15, wherein performing one or more activities comprises:
providing a notification indicating the preferences pertaining to the entity.

17. The method as recited in claim 16, wherein the notification is transmitted when the entity enters into or is in an estimated field of vision of a user of the apparatus.

18. The method as recited in claim 15, wherein performing one or more activities comprises:
identifying or receiving a photograph including a representation of the entity or portion thereof;
modifying the photograph including the representation of the entity or portion thereof such that at least a portion of the photograph including the representation of the entity or portion thereof is blurred or removed; and
storing the modified photograph.

19. The method as recited in claim 15, wherein performing one or more activities comprises:
providing a notification that a photograph including a representation of the entity or portion thereof has been taken.

20. The method as recited in claim 15, further comprising:
receiving a message from a device, the message pertaining to photographing the entity;
wherein performing at least one of the activities is initiated in response to the message.
